(19) United States
(12) Patent Application Publication
(10) Pub. No.: US 2009/0234718 A1
(43) Pub. Date: Sep. 17, 2009

(54) PREDICTIVE SERVICE SYSTEMS USING EMOTION DETECTION

(75) Inventor: Tammy Green, Provo, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/469,615

(22) Filed: May 20, 2009

Related U.S. Application Data
(63) Continuation-in-part of application No. 12/267,279, filed on Nov. 7, 2008.
Application No. 12/267,279 is a continuation-in-part of application No. 11/554,476, filed on Oct. 30, 2006, now Pat. No. 7,562,011.
Application No. 11/554,476 is a continuation of application No. 09/653,713, filed on Sep. 5, 2000, now Pat. No. 7,286,977.

(51) Int. Cl. G06Q 10/00; G06N 5/02

(52) U.S. Cl. 705/10; 706/52

(57) ABSTRACT

A predictive service system can include a gathering service to gather user information, a semantic service to generate a semantic abstract for the user information, an emotion detection service to identify emotion-related information, and a predictive service to act on an actionable item that is created based on the user information, the semantic abstract, and the emotion-related information.

### CROSS-REFERENCE TO RELATED APPLICATIONS

This application is a continuation-in-part of U.S. patent application Ser. No. 12/267,279, titled “PREDICTIVE SERVICE SYSTEMS,” filed on Nov. 7, 2008, which is a continuation-in-part of U.S. patent application Ser. No. 11/554,476, titled “INTENTIONAL-STANCE CHARACTERIZATION OF A GENERAL CONTENT STREAM OR REPOSITORY,” filed on Oct. 30, 2006, which is a continuation of U.S. patent application Ser. No. 09/653,713, filed on Sep. 5, 2000, which issued as U.S. Pat. No. 7,286,977 on Oct. 23, 2007. All of the foregoing applications are fully incorporated by reference herein.

This application is related to co-pending and commonly owned U.S. patent application Ser. No. 11/929,678, titled “CONSTRUCTION, MANIPULATION, AND COMPARISON OF A MULTI-DIMENSIONAL SEMANTIC SPACE,” filed on Oct. 30, 2007, which is a divisional of U.S. patent application Ser. No. 11/562,337, filed on Nov. 21, 2006, which is a continuation of U.S. patent application Ser. No. 09/512,963, filed Feb. 25, 2000, now U.S. Pat. No. 7,152,031, issued on Dec. 19, 2006. All of the foregoing applications are fully incorporated by reference herein.

This application is also related to co-pending and commonly owned U.S. patent application Ser. No. 11/616,154, titled “SYSTEM AND METHOD OF SEMANTIC CORRELATION OF RICH CONTENT,” filed on Dec. 26, 2006, which is a continuation-in-part of U.S. patent application Ser. No. 11/563,659, titled “METHOD AND MECHANISM FOR THE CREATION, MAINTENANCE, AND COMPARISON OF SEMANTIC ABSTRACTS,” filed on Nov. 27, 2006, which is a continuation of U.S. patent application Ser. No. 09/615,726, filed on Jul. 13, 2000, now U.S. Pat. No. 7,197,451, issued on Mar. 27, 2007; and is a continuation-in-part of U.S. patent application Ser. No. 11/468,684, titled “WEB-ENHANCED TELEVISION EXPERIENCE,” filed on Aug. 30, 2006; and is a continuation-in-part of U.S. patent application Ser. No. 09/691,629, titled “METHOD AND MECHANISM FOR SUPERPOSITIONING STATE VECTORS IN A SEMANTIC ABSTRACT,” filed on Oct. 18, 2000, now U.S. Pat. No. 7,389,225, issued on Jun. 17, 2008; and is a continuation-in-part of U.S. patent application Ser. No. 11/554,476, titled “INTENTIONAL-STANCE CHARACTERIZATION OF A GENERAL CONTENT STREAM OR REPOSITORY,” filed on Oct. 30, 2006, which is a continuation of U.S. patent application Ser. No. 09/653,713, filed on Sep. 5, 2000, now U.S. Pat. No. 7,286,977, issued on Oct. 23, 2007. All of the foregoing applications are fully incorporated by reference herein.

This application is also related to co-pending and commonly owned U.S. patent application Ser. No. 09/710,027, titled “DIRECTED SEMANTIC DOCUMENT PEDIGREE,” filed on Nov. 7, 2000, which is fully incorporated by reference herein.

This application is also related to co-pending and commonly owned U.S. patent application Ser. No. 11/638,121, titled “POLICY ENFORCEMENT VIA ATTESTATIONS,” filed on Dec. 13, 2006, which is a continuation-in-part of U.S. patent application Ser. No. 11/225,993, titled “CRAFTED IDENTITIES,” filed on Sep. 14, 2005, and is a continuation-in-part of U.S. patent application Ser. No. 11/225,994, titled “ATTESTED IDENTITIES,” filed on Sep. 14, 2005. All of the foregoing applications are fully incorporated by reference herein.

This application is also related to and fully incorporates by reference the following co-pending and commonly owned patent applications: U.S. patent application Ser. No. 12/346,657, titled “IDENTITY ANALYSIS AND CORRELATION,” filed on Dec. 30, 2008; U.S. patent application Ser. No. 12/346,662, titled “CONTENT ANALYSIS AND CORRELATION,” filed on Dec. 30, 2008; and U.S. patent application Ser. No. 12/346,665, titled “ATTRIBUTION ANALYSIS AND CORRELATION,” filed on Dec. 30, 2008.

This application also fully incorporates by reference the following commonly owned patents: U.S. Pat. No. 6,108,619, titled “METHOD AND APPARATUS FOR SEMANTIC CHARACTERIZATION OF GENERAL CONTENT STREAMS AND REPOSITORIES,” U.S. Pat. No. 7,177,922, titled “POLICY ENFORCEMENT USING THE SEMANTIC CHARACTERIZATION OF TRAFFIC,” and U.S. Pat. No. 6,650,777, titled “SEARCHING AND FILTERING CONTENT STREAMS USING CONTOUR TRANSFORMATIONS,” which is a divisional of U.S. Pat. No. 6,459,809.

### TECHNICAL FIELD

The disclosed technology pertains to various types of predictive service systems, and more particularly to implementations of predictive service systems that incorporate the use of emotion detection.

### BACKGROUND

U.S. patent application Ser. No. 12/267,279, titled “PREDICTIVE SERVICE SYSTEMS,” describes a variety of predictive service systems that can be used to gather information about a user or a group of users (e.g., a collaboration group), analyze the gathered information to understand the user or group of users, and make predictions about what the user or group of users would like to do given a certain set of circumstances.

Predictive service systems, such as those described in the referenced patent application, can effectively correlate the vast multitude of user and/or collaboration content (e.g., documents and/or events) in order to enable a predictive service to provide meaningful recommendations, hints, tips, etc. to the user or group of users and, in some cases, take action based on the recommendations, hints, tips, etc. with or without user and/or collaboration authorization.

### SUMMARY

Embodiments of the disclosed technology can include a predictive service system operable to gather information about a user, including information pertaining to the user's emotions and feelings, analyze the gathered information to better understand the user, and make one or more predictions about what the user would like to do given a certain set of circumstances. By taking into account the user's emotions and feelings, the system can make even better predictions of the user's needs.

In certain embodiments, a predictive service system can include a gathering service operable to collect information (e.g., documents and/or events) and store the information in a data store. The predictive service system can also include a semantic service operable to evaluate the collected information in order to produce actionable items by creating semantic abstracts based on a document boundary, placing the semantic abstracts into semantic space, and measuring distances between the semantic abstracts.

In certain embodiments, the predictive service system can include an emotion detection service operable to identify and/or generate emotion-related data corresponding to the user or group, as described herein. The predictive service system can also include a predictive service operable to act on the actionable items in order to provide a user or group of users with particular events, hints, recommendations, etc. The predictive service can also create events, conduct business on behalf of the user, and perform certain actions such as arrange travel, delivery, etc. to expedite approved events.

Working in conjunction with each other, the semantic service, the emotion detection service, and the predictive service can collectively “learn” about a user or a group of users based on information provided directly and/or indirectly to the predictive service system. The predictive service is operable to correlate the “learned” information to generate the events, hints, recommendations, etc. The generation and incorporation of emotion-related and/or feelings-related data for a particular user or groups of users as described herein can significantly enhance the effectiveness of the actionable items discussed above.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows an example of a predictive service system having a gathering service, a semantic service, an emotion detection service, a predictive service, and an analysis module in accordance with embodiments of the disclosed technology.

FIG. 2 shows an example of a gathering service that can interactively access and gather content, events, etc. from a wide variety of sources, such as user documents, user events, and user content flow.

FIG. 3 shows an example of a gathering service that can interactively access and gather content, events, etc. from collaboration documents, collaboration events, and collaboration content flow.

FIG. 4 shows an example of a gathering service that can interactively access and gather content from private content, world content, and restricted content.

FIG. 5 shows a flowchart illustrating an example of a method of constructing a directed set.

FIG. 6 shows a flowchart illustrating an example of a method of adding a new concept to an existing directed set.

FIG. 7 shows a flowchart illustrating an example of a method of updating a basis, either by adding to or removing from the basis chains.

FIG. 8 shows a flowchart illustrating an example of a method of updating a directed set.

FIG. 9 shows a flowchart illustrating an example of a method of using a directed set to refine a query.

FIG. 10 shows a flowchart illustrating an example of a method of constructing a semantic abstract for a document based on dominant phrase vectors.

FIG. 11 shows a flowchart illustrating an example of a method of constructing a semantic abstract for a document based on dominant vectors.

FIG. 12 shows a flowchart illustrating an example of a method of comparing two semantic abstracts and recommending a second content that is semantically similar to a content of interest.

FIG. 13 illustrates a first example user scenario in which a user initially indicates to a predictive service system an explicit preference for early meetings.

FIG. 14 illustrates a second user scenario in which a predictive service system includes a gathering service that accesses a user's private content and an emotion detection service that identifies emotional content within the user's private content.

### DETAILED DESCRIPTION

When asked opinion questions, it is not uncommon for people to provide responses that are inherently skewed by the questioner and/or the audience that will receive the response. In addition, the responses are often skewed based on what time of day the questioner presented the question to the respondent. Also, if the questioner were to ask someone whether they like chocolate ice cream, the questioner might get a different answer from the respondent via the survey than from the user's freeform text (such as email, for example). In fact, the user may not even be aware that he or she actually feels that way. Furthermore, people are often are not aware of changes in their preferences. For example, someone may continue to eat a certain type of food or continue to attend the same type of opera despite a change in his or her tastes with respect to food and music.

Current computer-implemented applications do not take factors such as these into consideration, let alone make allowances for them. Also, applications that allow a user to set personal preferences (e.g., to “train” the system) accept the user's data with no questions asked, which often leads to services that cannot be smart enough to predict the programmatic response that is truly desired by the user.

Using the emotional or feelings-based content of a user's (or group's) blog postings, emails, twitters, etc., a computer-implemented system in accordance with the disclosed technology can advantageously associate both positive and negative emotions with certain subjects, topics, and events, for example. The user's (or group's) emotional response can thus provide additional weighting to information that is discovered by the predictive service system. In certain embodiments, the disclosed technology may be likened to a user's friend who, noting that the user is no longer happy with respect to a certain area, suggests that the user try something different that he or she may enjoy more.

Embodiments of the disclosed technology can provide a user and/or group of users with predictive services to provide, for example, a wide variety of suggestions, recommendations, and even offers based on events, desires, emotions, feelings, and habits of the user and/or group. Such predictive services can act on information gathered and correlations made to provide better service to the user and/or group. Embodiments of the disclosed technology can include “learning” appropriate behavior based on interactions with a user and/or group of users such as, but not limited to, information pertaining to emotion or feelings.

By detecting emotion around particular topics, implementations of the disclosed technology can effectively change recommendations and/or actions for the user. For example, if a user goes to dinner at an Italian restaurant and later comments in his or her blog that Italian food gives him or her bad indigestion, the system can essentially make a note to not suggest or make future reservations for the user at an Italian restaurant.

### Exemplary Predictive Service Systems

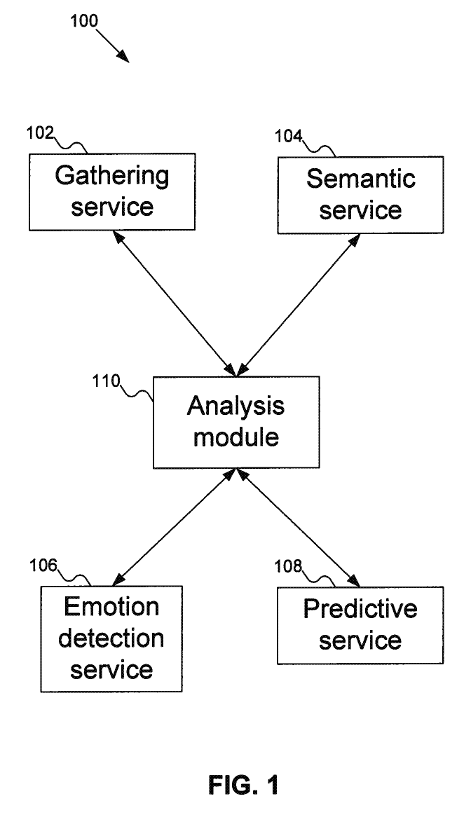

FIG. 1 shows an example of a predictive service system 100 that includes a gathering service 102, a semantic service 104, an emotion detection service 106, a predictive service 108, and an analysis module 110 in accordance with embodiments of the disclosed technology. One having ordinary skill in the art will recognize that the gathering service 102 can include one or more gathering services, the semantic service 104 can include one or more semantic services, and the predictive service 108 can include one or more predictive services. Examples of each of the components illustrated in FIG. 1 are discussed in detail below.

In certain embodiments, a predictive service system can have a confidence level with respect to certain types of information, including emotion-related information. In one example, the system can determine that a user might like to see a particular Opera. If the predictive service system has a high confidence level that the user would like the Opera, the predictive service system can automatically order tickets for the performance. If the confidence level is not as high, the predictive service system can alternatively inform the user of the Opera and ask the user certain questions to determine whether to add the Opera to the user's preferences, for example, for future reference.

### Exemplary Gathering Services

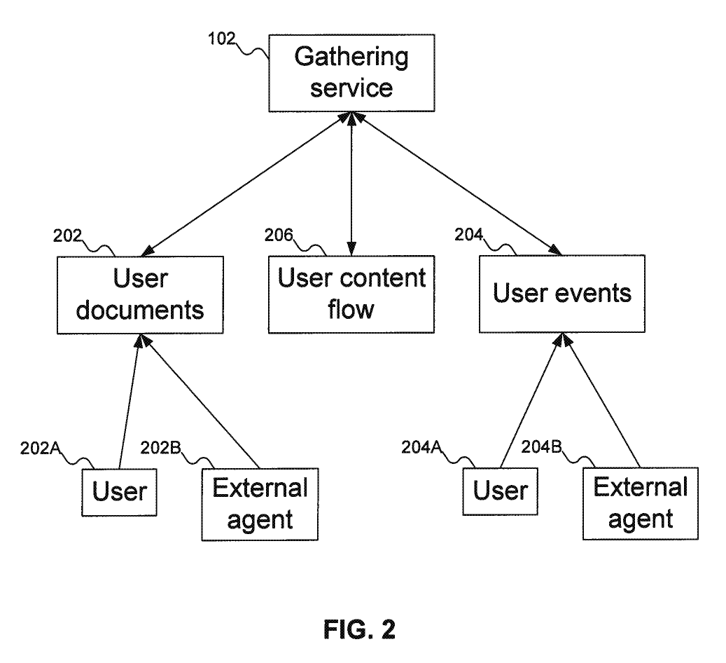

An example of the gathering service 102 is illustrated in FIG. 2, in which the gathering service 102 can interactively access and gather content, events, etc. from a wide variety of sources, such as user documents 202, user events 204, and user content flow 206. For example, each user of the system can have his or her own user documents 202 and user events 204.

User documents 202 can include Microsoft Office (e.g., Word and Excel) documents, e-mail messages and address books, HTML documents (e.g., that were downloaded by the user, intentionally or incidentally), and virtually anything in a readable file (e.g., managed by the user). User documents 202 can also include stored instant messaging (IM) data (e.g., IM sessions or transcripts), favorite lists (e.g., in an Internet browser), Internet browser history, weblinks, music files, image files, vector files, log files, etc.

User documents 202 can be directly controlled by a user 202A or added via one or more external agents 202B. As used herein, external agents generally refer to, but are not limited to, RSS feeds, spiders, and bots, for example.

User documents 202 can be stored in a document store that the user has access to and can manage. For example, user documents 202 can be stored locally (e.g., on a local disc or hard drive) or in a storage area that the user can access, manage, or subscribe to.

User events 204 can include a calendar item (e.g., something planned to occur at a particular time/place such as a meeting or a trip), a new category in a blog, or a user's blocking out of an entire week with a note stating that “I need to set up a meeting this week.” The simple fact that a blog was created or accessed can be a user event 204.

User events 204 can be directly controlled by a user 204A or added via one or more external agents 204B. The user 204A can be the same user 202A that controls the user events 202 or a different user. The external agent 204B can be the same external agent 202B (or same type of agent) that adds to the user events 202 or a different external agent entirely. An exemplary directly-controlled user event can include an appointment or “to-do” added in a calendar application (e.g., Microsoft Outlook). An exemplary event added by an external agent can include an appointment to the user's own calendar application from an event in an external calendar application (e.g., a meeting scheduled in another user's calendar application).

As used herein, user content flow 206 generally represents network or content traffic that moves events and/or content from one place to another, such as a user adding, deleting, or editing a user document 202, a user document 202 affecting another user document 202, or a user event 204 affecting one or more user documents 202, for example. User content flow 206 can also refer to a sequence of things that happen to one or more events and/or content as time progresses (such as a monitoring of TCP/IP traffic and other types of traffic into and/or out of the user's local file system, for example).

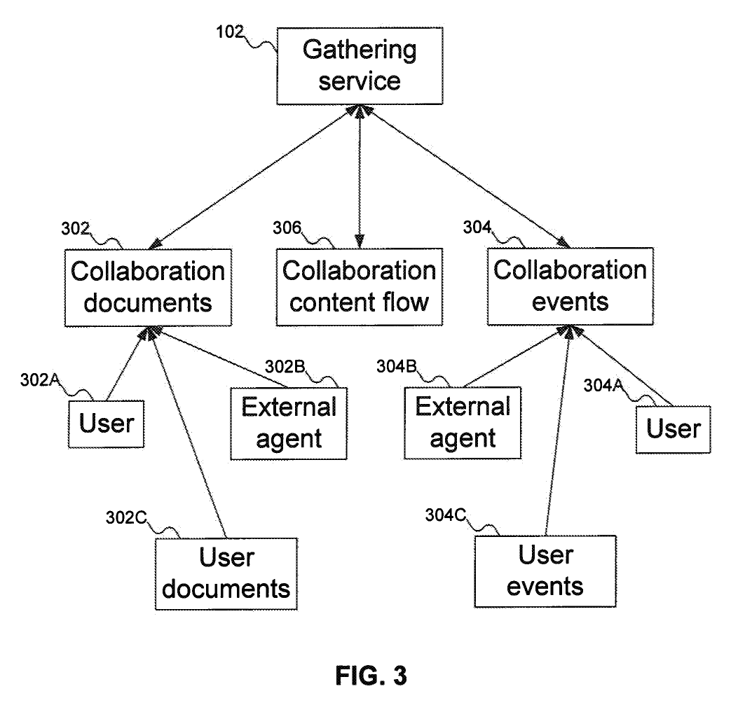

FIG. 3 illustrates that the gathering service 102 can also interactively access and gather content, events, etc. from collaboration documents 302, collaboration events 304, and collaboration content flow 306. Such interaction between the gathering service 102 and one or more of the collaboration components 302, 304, and 306 can occur concurrently with or separately from interaction between the gathering service 102 and one or more of the user components 202, 204, and 206 (as shown in FIG. 2). As used herein, a collaboration generally refers to a group of individual users.

Collaboration documents 302 can be directly controlled by a user or any number of members of a group or groups of users 302A or added via one or more external agents 302B. As discussed above, external agents generally refer to, but are not limited to, RSS feeds, spiders, and bots, for example. Collaboration documents 302 can include Microsoft Office (e.g., Word and Excel) documents, e-mail messages and address books, HTML documents (e.g., that were downloaded by the user, intentionally or incidentally), and virtually anything in a readable file. Collaboration documents 302 can also include stored instant messaging (IM) data (e.g., IM sessions or transcripts), favorite lists (e.g., in an Internet browser), Internet browser history, music files, image files, vector files, log files, etc. of one or more users. Collaboration documents 302 can also include, for example, the edit history of a wiki page.

Collaboration documents 302 can be stored in a document store that a particular user or members of a group or groups of users have access to and can manage. For example, collaboration documents 302 can be stored on a disc or hard drive local to a particular user or members of a group or groups of users or in a storage area that the user or member of the group or groups of users can access, manage, or subscribe to.

Collaboration events 304 can be directly controlled by a user or member of a group or groups of users 304A or added via one or more external agents 304B. The user or members of a group or groups of users 304A can be the same user or members 302A that control the collaboration events 302 or a different user or members. The external agent 304B can be the same external agent 302B (or same type of agent) that adds to the collaboration events 302 or a different external agent entirely. An exemplary directly-controlled user event can include an appointment or “to-do” added in a calendar application (e.g., Microsoft Outlook) shared by or accessible to a number of users. An exemplary event added by an external agent can include an appointment to the shared calendar application from an event in an external calendar application (e.g., a meeting scheduled in a different group's calendar application).

As used herein, collaboration content flow 306 generally represents network or content traffic that moves events and/or content from one place to another, such as a user or members of a group or groups adding, deleting, or editing a collaboration document 302, a collaboration document 302 affecting another collaboration document 302, or a collaboration event 304 affecting one or more collaboration documents 302, for example.

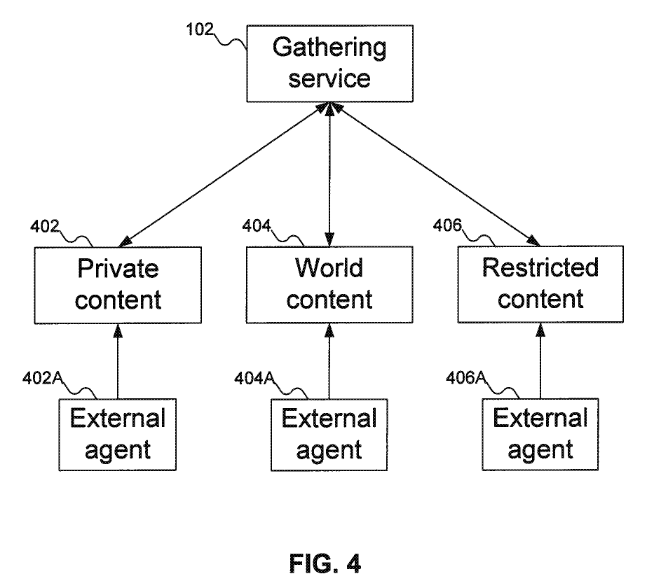

FIG. 4 illustrates that the gathering service 102 can also interactively access and gather content from private content 402, world content 404, and restricted content 406. Such interaction between the gathering service 102 and one or more of the private content 402, world content 404, and restricted content 406 can occur concurrently with or separately from interaction between the gathering service 102 and one or more of the user components 202, 204, and 206 (as shown in FIG. 2) and one or more of the collaboration components 302, 304, and 306 (as shown in FIG. 3).

As used herein, private content 402 generally refers to content under the control of a particular user that may be outside of the containment of user documents such as the user documents 202 of FIG. 2. The private content 402 is typically content that the user chooses to hold more closely and not make available to a gathering service (such as gathering service 102 in FIGS. 1-3), even in instances where one or more policy services manages access to the private content 402. One or more external agents 402A can provide input to the private content 402.

As used herein, world content 404 generally refers to content that is usually publicly available, such as Internet content that has no access controls. One or more external agents 404A can provide input to the world content 404.

As used herein, restricted content 406 generally refers to content that is provided to a user under some type of license or access control system. In certain embodiments, restricted content 406 is provided by an enterprise as content that is considered to be proprietary or secret to the enterprise, for example. Restricted content can also include content such as travel information pertaining to a travel service that the user has used (e.g., subscribed to) for actual or possible travel plans, for example. One or more external agents 406A can provide input to the restricted content 406.

With appropriate access permissions, embodiments of the disclosed technology can provide for one or more gathering services (e.g., gathering service 102 of FIGS. 1-4) that can access and gather content and/or events from virtually any combination of user documents, user events, user content flow, collaboration documents, collaboration events, collaboration content flow, private content, world content, and restricted content.

### Exemplary Multi-Dimensional Semantic Space

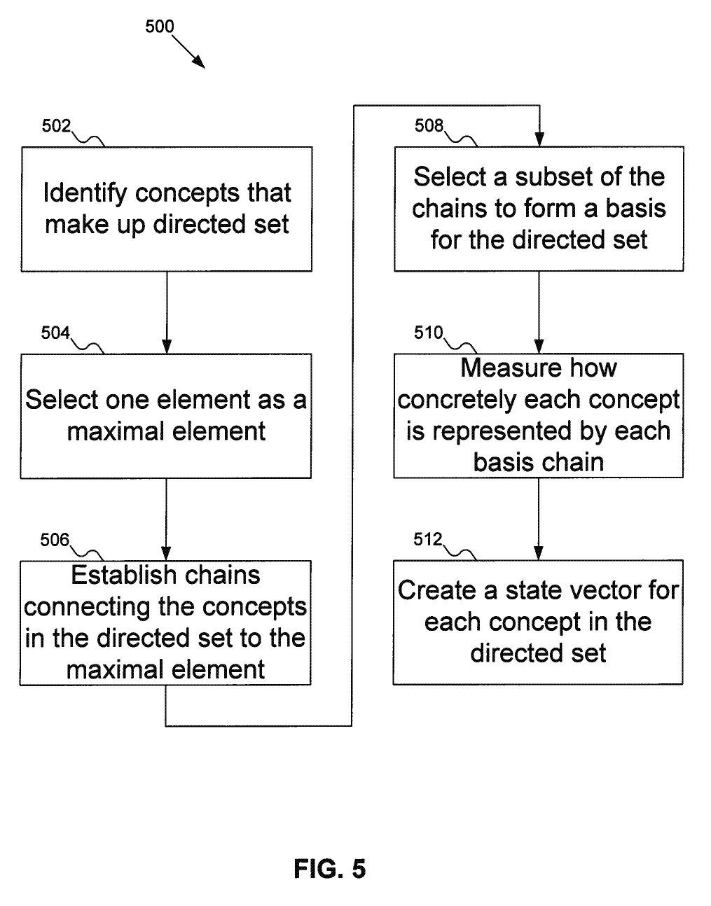

An example of constructing a semantic space can be explained with reference to FIG. 5, which shows a flowchart illustrating an example of a method 500 of constructing a directed set. At 502, the concepts that will form the basis for the semantic space are identified. These concepts can be determined according to a heuristic, or can be defined statically. At 504, one concept is selected as the maximal element.

At 506, chains are established from the maximal element to each concept in the directed set. There can be more than one chain from the maximal element to a concept: the directed set does not have to be a tree. Also, the chains generally represent a topology that allows the application of Uryshon's lemma to metrize the set. At 508, a subset of the chains is selected to form a basis for the directed set.

At 510, each concept is measured to see how concretely each basis chain represents the concept. Finally, at 512, a state vector is constructed for each concept, where the state vector includes as its coordinates the measurements of how concretely each basis chain represents the concept.

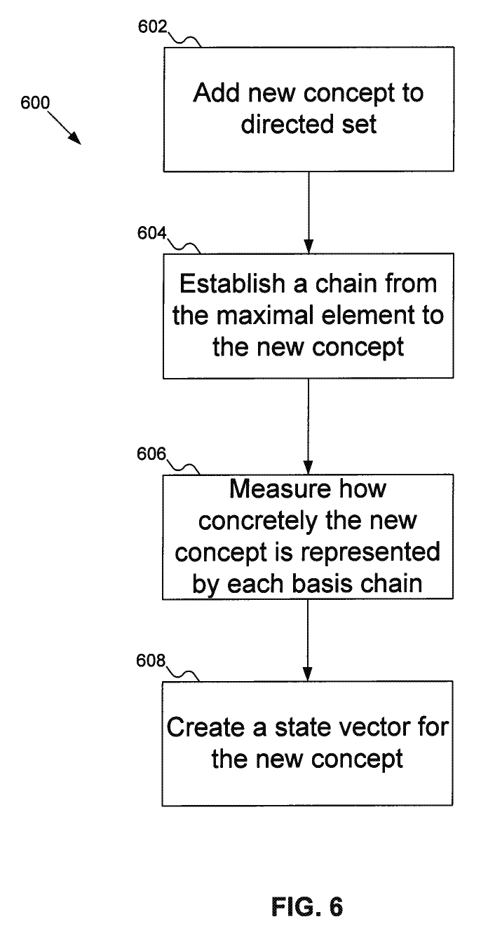

FIG. 6 shows a flowchart illustrating an example of a method 600 of adding a new concept to an existing directed set. At 602, the new concept is added to the directed set. The new concept can be learned by any number of different means. For example, the administrator of the directed set can define the new concept. Alternatively, the new concept can be learned by listening to a content stream. One having ordinary skill in the art will recognize that the new concept can be learned in other ways as well. The new concept can be a “leaf concept” (e.g., one that is not an abstraction of further concepts) or an “intermediate concept” (e.g., one that is an abstraction of further concepts).

At 604, a chain is established from the maximal element to the new concept. Determining the appropriate chain to establish to the new concept can be done manually or based on properties of the new concept learned by the system. One having ordinary skill in the art will also recognize that more than one chain to the new concept can be established.

At 606, the new concept is measured to see how concretely each chain in the basis represents the new concept. Finally, at 608, a state vector is created for the new concept, where the state vector includes as its coordinates the measurements of how concretely each basis chain represents the new concept.

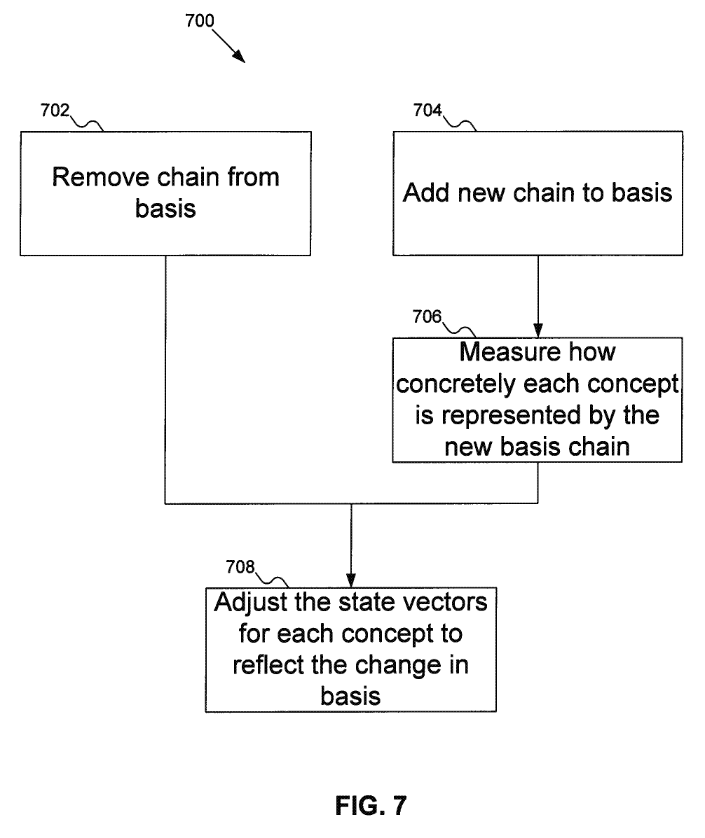

FIG. 7 shows a flowchart illustrating an example of a method 700 of updating the basis, either by adding to or removing from the basis chains. If chains are to be removed from the basis, then the chains to be removed are deleted, as shown at 702. Otherwise, new chains are added to the basis, as shown at 704. If a new chain is added to the basis, each concept must be measured to see how concretely the new basis chain represents the concept, as shown at 706. Finally, whether chains are being added to or removed from the basis, the state vectors for each concept in the directed set are updated to reflect the change, as shown at 708.

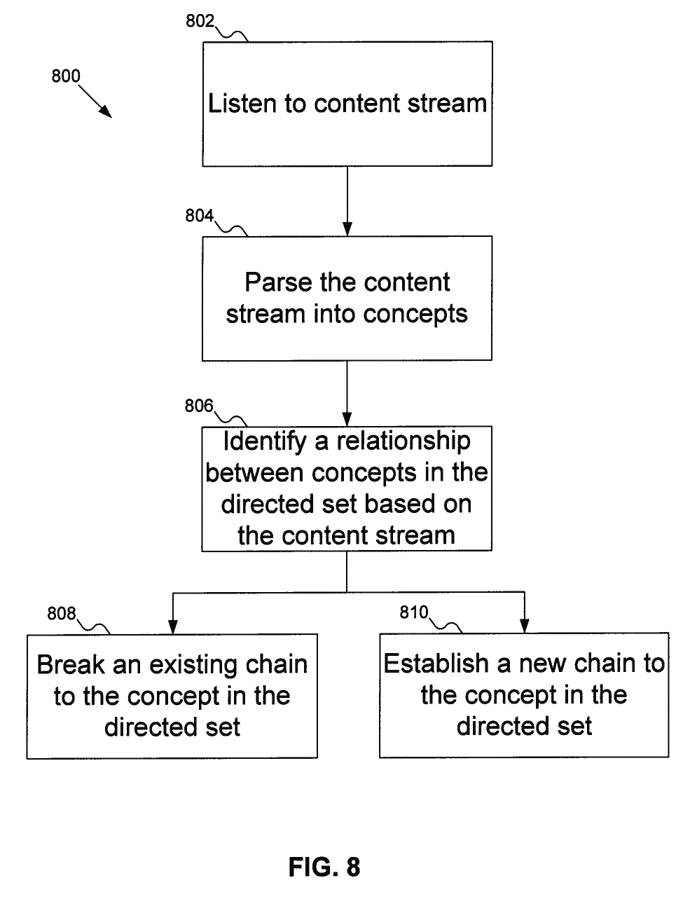

FIG. 8 shows a flowchart illustrating an example of a method 8000 of updating the directed set. At 8002, the system is listening to a content stream. At 8004, the system parses the content stream into concepts. At 8006, the system identifies relationships between concepts in the directed set that are described by the content stream. Then, if the relationship identified at 8006 indicates that an existing chain is incorrect, the existing chain is broken, as shown at 8008. Alternatively, if the relationship identified at 8006 indicates that a new chain is needed, a new chain is established, as shown at 8010.

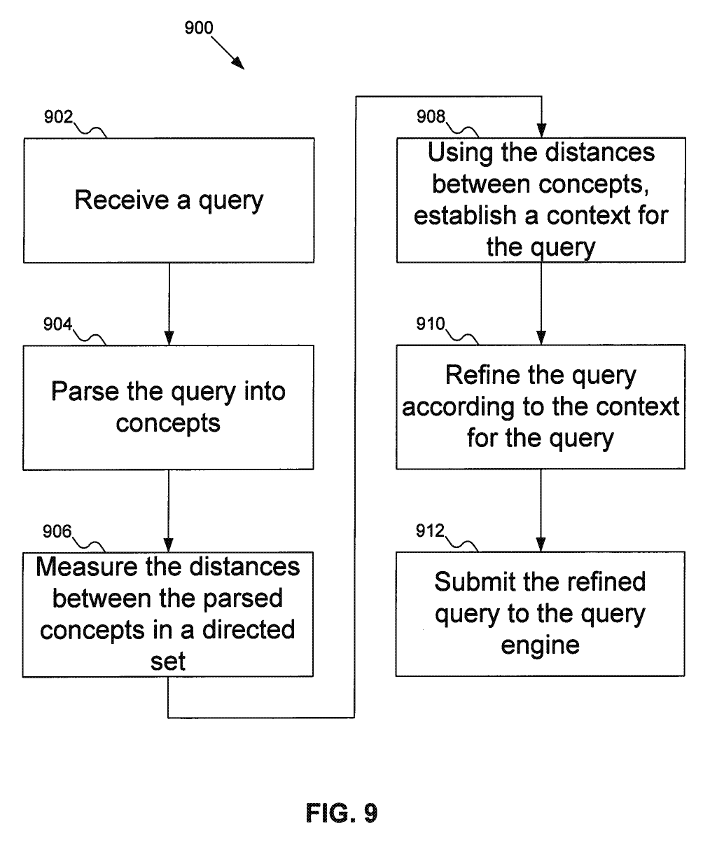

FIG. 9 shows a flowchart illustrating an example of a method 900 of using a directed set to refine a query (such as to a database, for example). At 902, the system receives the query. At 904, the system parses the query into concepts. At 906, the distances between the parsed concepts are measured in a directed set. At 908, using the distances between the parsed concepts, a context is established in which to refine the query. At 910, the query is refined according to the context. Finally, at 912, the refined query is submitted to the query engine.

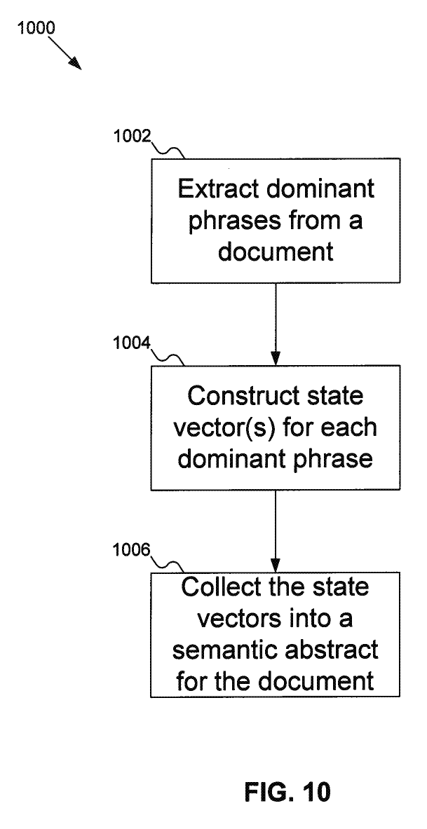

FIG. 10 shows a flowchart illustrating an example of a method 1000 of constructing a semantic abstract for a document based on dominant phrase vectors. At 1002, phrases (the dominant phrases) are extracted from the document. The phrases can be extracted from the document using a phrase extractor, for example. At 1004, state vectors (the dominant phrase vectors) are constructed for each phrase extracted from the document. One having ordinary skill in the art will recognize that there can be more than one state vector for each dominant phrase. At 1006, the state vectors are collected into a semantic abstract for the document.

Phrase extraction can generally be done at any time before the dominant phrase vectors are generated. For example, phrase extraction can be done when an author generates the document. In fact, once the dominant phrases have been extracted from the document, creating the dominant phrase vectors does not require access to the document at all. If the dominant phrases are provided, the dominant phrase vectors can be constructed without any access to the original document.

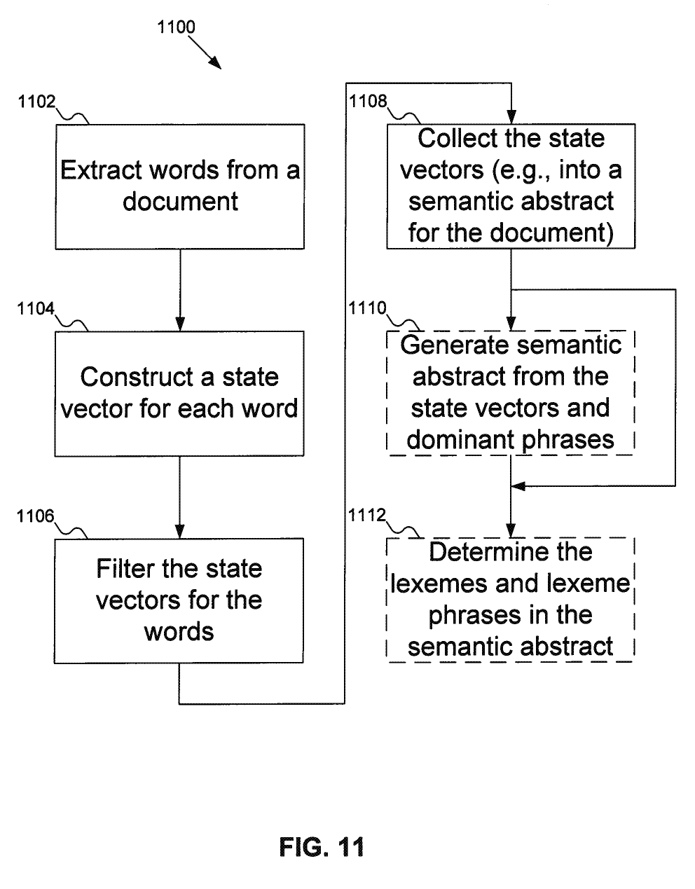

FIG. 11 shows a flowchart illustrating an example of a method 1100 of constructing a semantic abstract for a document based on dominant vectors. At 1102, words are extracted from the document. The words can be extracted from the entire document or from only portions of the document (such as one of the abstracts of the document or the topic sentences of the document, for example). At 1104, a state vector is constructed for each word extracted from the document. At 1106, the state vectors are filtered to reduce the size of the resulting set, producing the dominant vectors. Finally, at 1108, the filtered state vectors are collected into a semantic abstract for the document.

FIG. 11 shows two additional steps that are also possible in the example. At 1110, the semantic abstract is generated from both the dominant vectors and the dominant phrase vectors. The semantic abstract can be generated by filtering the dominant vectors based on the dominant phrase vectors, by filtering the dominant phrase vectors based on the dominant vectors, or by combining the dominant vectors and the dominant phrase vectors in some way, for example. Finally, at 1112, the lexeme and lexeme phrases corresponding to the state vectors in the semantic abstract are determined.

As discussed above regarding phrase extraction in FIG. 10, the dominant vectors and the dominant phrase vectors can be generated at any time before the semantic abstract is created. Once the dominant vectors and dominant phrase vectors are created, the original document is not necessarily required to construct the semantic abstract.

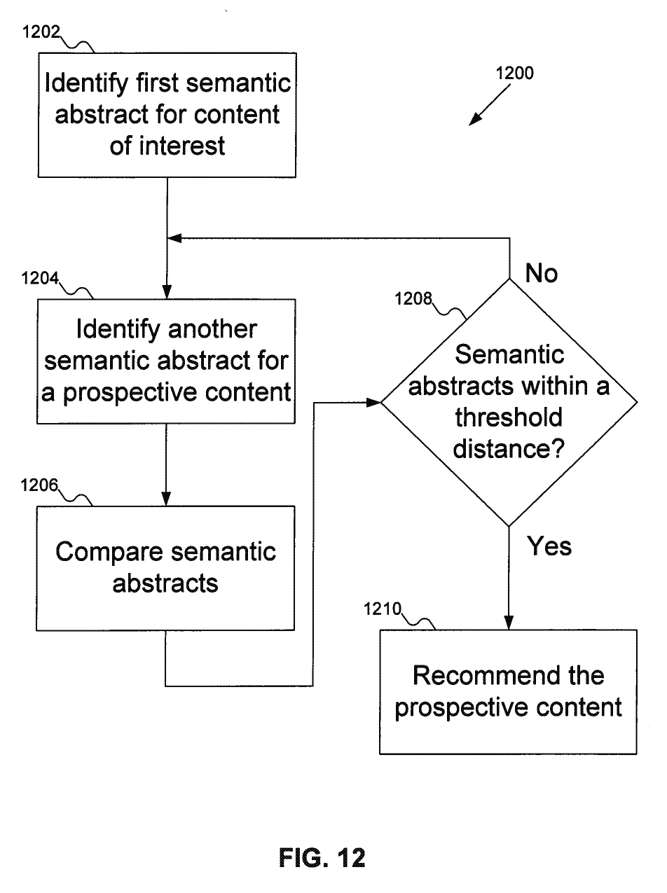

FIG. 12 shows a flowchart illustrating an example of a method 1200 of comparing two semantic abstracts and recommending a second content that is semantically similar to a content of interest. At 1202, a semantic abstract for a content of interest is identified. At 1204, another semantic abstract representing a prospective content is identified. In either or both 1202 and 1204, identifying the semantic abstract can include generating the semantic abstracts from the content, if appropriate. At 1206, the semantic abstracts are compared. Next, a determination is made as to whether the semantic abstracts are “close,” as shown at 1208. In the example, a threshold distance is used to determine if the semantic abstracts are “close.” However, one having ordinary skill in the art will recognize that there are various other ways in which two semantic abstracts can be deemed “close.”

If the semantic abstracts are within the threshold distance, then the second content is recommended to the user on the basis of being semantically similar to the first content of interest, as shown at 1210. If the other semantic abstracts is not within the threshold distance of the first semantic abstract, however, then the process returns to step 1204, where yet another semantic abstract is identified for another prospective content. Alternatively, if no other content can be located that is “close” to the content of interest, processing can end.

In certain embodiments, the exemplary method 1200 can be performed for multiple prospective contents at the same time. In the present example, all prospective contents corresponding to semantic abstracts within the threshold distance of the first semantic abstract can be recommended to the user. Alternatively, the content recommender can also recommend the prospective content with the semantic abstract nearest to the first semantic abstract.

### Exemplary Emotion and Feeling Detection

Once the gathered information (e.g., as gathered by the gathering service 102 of FIG. 1) such as user documents and content flow, collaboration documents and content flow, and public and private content produced by the user, has been parsed into concepts, in accordance with the techniques discussed above, an emotion detection service (such as the emotion detection service 106 of FIG. 1, for example) can first identify any emotional text (e.g., emotion-related or feelings-related language) surrounding and/or associated with one or more of the concepts.

Such identification can be based on the notion that specific words have specific meeting (e.g., “happy” denotes a positive feeling). For example, the more a user posts comments such as “I am happy” on his or her MySpace or Facebook page, the more likely the user has positive emotion in connection with whatever he or she is referring to. In certain embodiments, words can be pre-scored. Such scoring can also be adjusted in a learning context. For example, the word “like” may be stronger for some users than others. Certain implementations can include a base set of pre-scored words that can change (e.g., based on user behavior).

The emotion detection service can then classify the identified emotional text as positive or negative. For example, whereas identified emotional text containing words such as “happy,” “love,” or “like” can be classified as positive emotional text, identified emotional text containing words such as “hate,” “loathe” or “dislike” can be classified as negative emotional text.

In certain embodiments, the emotion detection service can further classify the intensity of the emotional text (e.g., on a scale from 1 to 10, where “love” would be closer to 10 than “like” for a positive emotion intensity classification, for example). The emotion detection service can subsequently store this emotion intensity classification in association with the identified emotional text, for example. Alternatively, the emotion detection service can store each emotion intensity classification separately from the identified emotional text.

In certain implementations, the semantic service can use the emotion as well as the emotional intensity as weighting input for preferences recorded for the user. The semantic service can also use the emotion and emotional intensity to reorder a user's preferences. Such implementations can include an accumulation (e.g., collective storing) of data pertaining to the detected emotion as embodiments tend to focus on gradual and slight changes (e.g., “fine-tuning”) rather than immediate and sweeping changes.

In certain embodiments, the system can build several data points around a certain subject (e.g., types of opera) before making any decisions in connection with confirming assumptions about a user. In other words, the system is made to have a level of patience by not taking any substantive action until there is a certain preponderance of evidence. For example, the system can readily ignore a single instance of the word “hate” where the user has regularly used words such as “like” concerning a certain subject (e.g., on the user's blog) as an aberration, essentially recognizing that the single expression is more indicative of the user having a bad day than a set emotion about the matter. The more the user writes “hate,” however, particularly if the user uses “like” less, the more the system will deem the use of the word to be indicative of a pattern of negative emotion concerning the subject.

Embodiments of the disclosed technology can also recognize various types of inherent limitations. For example, the predictive service system can take note of situations in which a user's emotions indicate that the user does not like low-quality opera performances but that there are no high-quality opera performances in the user's area. Thus, the system can recognize that the user may not have had a fair chance of experiencing both low-quality and high-quality operas before expressing himself or herself in such a way that the system detected a negative emotion with respect to the opera that the user saw.

### Exemplary Predictive Services

Semantic processing of content (e.g., performed by the semantic service 104 of FIG. 1) and emotion/feeling detection (e.g., performed by the emotion detection service 106 of FIG. 1) can be used in conjunction with an analysis module (such as the analysis module 110 of FIG. 1) in order to provide one or more predictive services (such as the predictive service 108 of FIG. 1) with actionable analysis. In certain embodiments, the type of content processed can be used in determining which predictive service to invoke.

Based on the analysis provided by the analysis module, the predictive service can determine and provide correlated hints, suggestions, content change, events, prompts, etc. to a user or group of users (e.g., a collaboration group). The predictive service can be set to automatically take action on the hints, suggestions, etc., or to recommend to a user or collaboration that the hint or suggestion should be acted on [and then wait for a response from the user or collaboration].

Described below are several detailed examples (i.e., user scenarios) of implementations of predictive service systems.

Exemplary User Scenarios in Accordance with Implementations of the Disclosed Technology

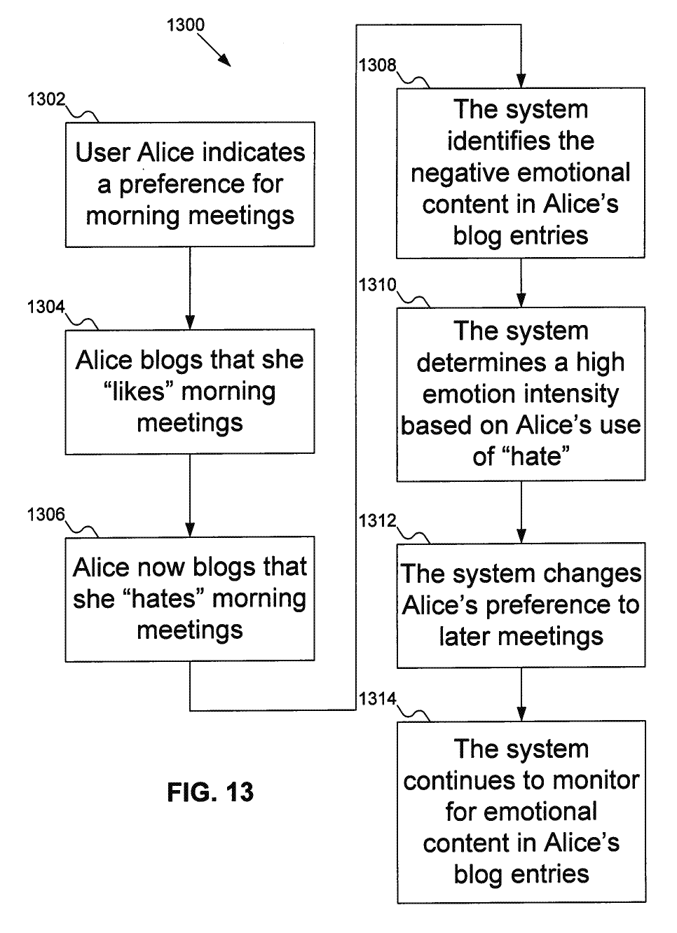

FIG. 13 illustrates a first example user scenario 1300, in which a user Alice initially indicates to a predictive service system an explicit preference for early meetings, as indicated at 1302. Alice then goes on to consistently accept her meetings and attend her meetings on time over a period of time (e.g., weeks or months). Alice also writes on her blog that she “likes” and “enjoys” the morning meetings, thereby reinforcing to the predictive service system that the indicated preference is true, as indicated at 1304.

However, after a certain period of time, Alice begins to consistently and routinely indicate in emails and regular blog postings that the early meetings are “difficult” for her and that she is “too tired to work” the rest of the day. Alice also indicates in her emails and blog postings that she “hates” having to get to work so early and that she “wishes” that the meetings could be held in the afternoon instead of in the morning, as indicated at 1306. As certain embodiments involve a level of patience, such embodiments tend to focus on a repetition of a certain type of detected emotion in connection with a certain concept.

The predictive service system, detecting the emotional content associated with the concept of early morning meetings, as indicated at 1308, will thus interpret a negative emotion around early meetings and give it a relatively high emotion intensity based on the use of the word “hate” in several emails, as indicated at 1310. In the example, the predictive service system can assess a higher emotion intensity for the negative emotional content than the positive emotion content because the word “hate” is a stronger word than “like.” Thus, the number of instances of “hate” can be less than the number of instances of “like” before the predictive service system changes the classification of the emotional content from positive to negative.

Based on the detected emotional content and measurement of emotion intensity of the emotional content, the predictive system can change Alice's preference for early morning meetings such that, in the future, the predictive service system can suggest or automatically schedule Alice's meetings for a later time (e.g., an hour later), as indicated at 1312. The predictive service system can continue to gather data to monitor and measure the emotional effect (e.g., improvement) of changing Alice's preference to determine whether further modification is needed in the future, as indicated at 1314.

One having ordinary skill in the art will appreciate that a double negative is not necessarily considered a positive to a predictive service system in accordance with the disclosed technology. For example, if Alice consistently schedules morning meetings [but says nothing about them her blog, let alone whether she “hates” them] and also consistently schedules afternoon meetings [and comments that she “likes” them on her blog], the predictive service system will typically monitor such comments over a prolonged period of time before confirming any assumption that Alice likes or does not like morning meetings.

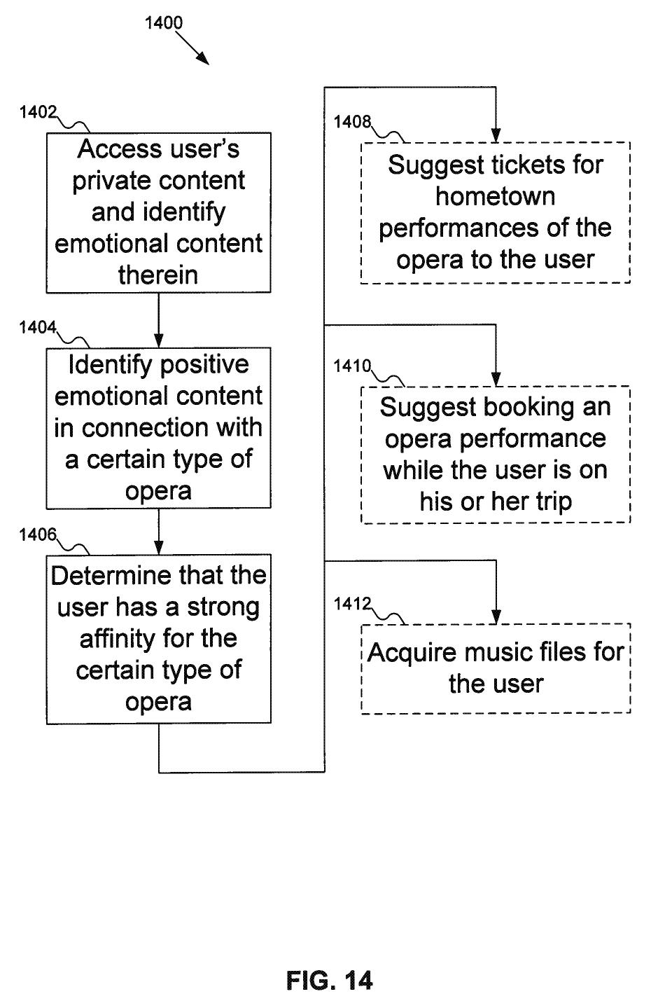

FIG. 14 illustrates a second user scenario 1400, in which a predictive service system includes a gathering service that accesses a user's private content and an emotion detection service that identifies emotional content within the user's private content, as indicated at 1402. In the example, the emotion detection service identifies positive emotional content associated with a certain type of Opera, as indicated at 1404. Furthermore, the emotion detection service determines that the positive emotional content has a high emotion intensity value, indicating that the user has a strong affinity for that particular type of Opera, as indicated at 1406.

The predictive service system can generate actionable items, based on the emotional content and the emotion intensity associated therewith. The system can also act on the actionable items by suggesting to the user (e.g., in the user's events) that tickets to certain performances of the pertinent type of Opera in the user's home town are available for purchase, for example, as indicated at 1408. The predictive service system can also provide the price of such tickets to the user, for example.

In situations where the user has a trip scheduled (e.g., to San Francisco) and the predictive service system has identified a jazz show and an Opera that are both playing in San Francisco during the time that the user is in San Francisco, the predictive service system can recommend to the user getting tickets for (or, alternatively, automatically order tickets for) the Opera performance rather than the jazz show based on the user's previous expressions of extreme like for Operas and dislike for jazz, as indicated at 1410.

In certain embodiments, the predictive service system can locate and automatically acquire (e.g., locate on the user's desktop or purchase from a third party) one or more music files (e.g., an mp3 file) containing the type of music that would be heard in the pertinent type of Opera and suggest the music file(s) to the user, as indicated at 1412. The user can then decide whether to listen to, save, or delete the music file(s), for example.

In other types of user scenarios, a group of people can be polled using a survey that allows those being polled to provide free-form comments. For example, when an entity (e.g., a government entity) holds some type of vote (e.g., an election), the voting ballot can include a free-form entry to enable each voter to say how he or she feels about the country and/or the item being voted upon (e.g., bill). In such scenarios, little if any attention is paid to the actual numerical data as the system is much more interested in the free-form comments to the question results as emotional content for the group can be identified and emotion intensity of the emotional content can be measured based on the free-form comments.

In a presidential election, for example, each presidential candidate can essentially put a whiteboard online to allow supporters and non-supporters alike to express themselves in order to get a more accurate feel than a “regular” poll would provide. If a candidate's supporters are speaking in middle terms, for example, the approval rating for that candidate may not be as high as otherwise indicated based on raw data taken from a “regular” poll.

Similar techniques can be used in certain implementations to scan the general mood of a group of people such as employees, team members, volunteers, and citizens based on their public content. For example, companies can take periodic surveys of employees. Freeform comments often reveal a story that can be quite different than what raw numbers suggest. In an exemplary scenario, a company can determine that over 80% of its employees actually have some level of dissatisfaction despite numbers that suggest a total employee happiness with the company.

In certain embodiments, the reaction of a class to a speaker can be more effectively gauged than by a typical “numbers-only” poll. In such embodiments, a first differentiator can include identifying positive emotional content and rating the emotion intensity on a scale of 1 to 5. Negative content (e.g., as expressed by a certain number of people that each had a strong negative reaction to the speaker) can also be identified and measure. Thus, the system can provide the speaker with a determination that there were, in fact, two different audiences—those who liked him or her and those that did not. The speaker is thus enabled by being presented with a need to have two different lectures (e.g., for each of two different populations).

Using techniques described herein, a university professor can effectively quantify the success of his or her lecture based on a certain number of students' blogs. For example, if a majority of the students expressed content on their blogs that contained positive emotional content with respect to the lecture, the system can affirm that the professor's lecture went well. If, on the other hand, the majority of students' blog entries contained negative emotional content regarding the lecture, the professor may want to consider revising or dropping that lecture in the future.

In certain embodiments, a recording tool can be used in connection with a questionnaire. In such embodiments, the system can classify people based on additional details provided by the people. For example, a company may have engineers that don't like a certain input system. Using the techniques described herein, a text analysis can determine that the engineers dislike doing the input themselves. Thus, the system can determine that the perceived negative rating is not actually with respect to the tool but with respect to the process surrounding the tool. One having ordinary skill in the art will appreciate that this is a different kind of information than a broad survey result would yield.

General Description of a Suitable Machine in which Embodiments of the Disclosed Technology can be Implemented

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, and the like.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A predictive service system, comprising:
at least one gathering service operable to gather user information pertaining to at least one user;
at least one semantic service operable to generate at least one semantic abstract for the user information;
at least one emotion detection service operable to generate emotion-related information pertaining to the at least one user; and
at least one predictive service operable to act on at least one actionable item based at least in part on the user information, the at least one semantic abstract, and the emotion-related information.

2. The predictive service system of claim 1, further comprising an analysis module in communication with the at least one gathering service, the at least one semantic service, the at least one emotion detection service, and the at least one predictive service, wherein the analysis module is operable to create the at least one actionable item and send the at least one actionable item to the at least one predictive service.

3. The predictive service system of claim 1, wherein the at least one emotion detection service is further operable to classify the emotion-related information.

4. The predictive service system of claim 3, wherein the at least one emotion detection service is further operable to determine an emotion intensity level of the emotion-related information.

5. The predictive service system of claim 1, wherein the user information comprises at least one of a user document and a user event.

6. The predictive service system of claim 1, wherein the user information comprises information pertaining to a user content flow.

7. The predictive service system of claim 1, wherein the at least one actionable item comprises at least one of a user recommendation, a user suggestion, and a user tip.

8. The predictive service system of claim 1, wherein the user information is gathered from a user questionnaire, the user questionnaire having a section for free-form comments.

9. A computer-implemented method, comprising:
gathering user information from at least one source;
creating at least one semantic abstract corresponding to the user information;
identifying emotion-related information within the at least one semantic abstract; and
creating at least one actionable item based at least in part on the at least one semantic abstract and the identified emotion-related information.

10. The computer-implemented method of claim 9, wherein the at least one source comprises at least one of a user document and a user event.

11. The computer-implemented method of claim 9, wherein the at least one source comprises at least one of private content, world content, and restricted content.

12. The computer-implemented method of claim 9, further comprising automatically executing the at least one actionable item.

13. The computer-implemented method of claim 9, further comprising classifying the emotion-related information.

14. The computer-implemented method of claim 13, further comprising assigning an emotion intensity value to the emotion-related information.

15. The computer-implemented method of claim 14, wherein the at least one actionable item is based at least in part on the emotion intensity value of the emotion-related information.

16. A system, comprising:
a gathering module to gather group information pertaining to a group of users;
a semantic module to create a semantic abstract based at least in part on the group information;
an emotion detection module to detect at least one emotion-related item within the semantic abstract; and
an analysis module to generate an output based at least in part on a correlation of at least two of the user information, the semantic abstract, and the at least one emotion-related item.

17. The system of claim 16, further comprising a predictive service module to implement the output from the analysis module.

18. The system of claim 16, wherein the predictive service module implements the output by providing the user with a recommendation.

19. The system of claim 18, wherein the predictive service module implements the output by updating the recommendation based on a newly detected emotion-related item.

20. The system of claim 16, further comprising an emotion intensity measurement module operable to measure an emotion intensity level of the at least one emotion-related item.

21. The system of claim 20, wherein the generated output is further based on the emotion intensity level.
